(19) United States
(12) Patent Application Publication
(10) Pub. No.: US 2009/0099954 A1
(43) Pub. Date: Apr. 16, 2009

(54) Systems and Methods for Managing Zoning Information

(75) Inventor: Robert Llewellyn Kilby, Snellville, GA (US)

Correspondence Address: Robert Llewellyn Kilby;eFacilitationPathway, 3825 Cannonwolde Drive, Snelville, GA, 30039, US

(73) Assignee: eFacilitationPATHways, Inc., Duluth, GA (US)

(21) Appl. No.: 11/967,495

(22) Filed: Dec. 31, 2007

Related U.S. Application Data
(60) Provisional application No. 60/979,737, filed on Oct. 12, 2007.

(51) Int. Cl. G06Q 10/00

(52) U.S. Cl. 705/37; 705/1

(57) ABSTRACT

A computer system and method that enables a user to meet the appropriate zoning, special use permit, and variance requirements for one or more zoning jurisdictions. The user may query a database for the zoning requirements and zoning requirement changes, facilitate the zoning processes, and generate deliverables for the various jurisdictions. An applicant of a zoning project may request and receive bids from contractors on the applicant's zoning project. The bid request is automatically populated with the relevant jurisdictional requirements.

### RELATED APPLICATION DATA

This application claims the benefit of the filing date and priority to the following patent application, which is incorporated herein by reference to the extent permitted by law:

U.S. Provisional Patent Application No. 60/979,737, entitled “System and Method for Generating Zoning Compliance Materials,” filed Oct. 12, 2007.

### FIELD OF INVENTION

The present invention generally relates to data processing systems; and more particularly to computer-implemented methods and systems for implementing zoning workflows and generating zoning deliverables for multiple zoning jurisdictions.

### BACKGROUND OF THE INVENTION

Real estate developers are typically involved in developing real estate in various jurisdictions, such as different states. Each jurisdiction has a unique set of rules, procedures, and processes that the developer must fulfill to zone a real estate property. Developers that do business in different jurisdictions must meet zoning requirements in each zoning jurisdictions.

Conventional systems provide zoning, special use permit (“SUP”), and variance information for a single jurisdiction. Users rely on several manual and disjointed processes to zone properties in the various jurisdictions. This is time consuming, redundant, and tedious. For developers residing in one state who would like to develop real estate in another state, the zoning, SUP, and variance requirements can be significantly different and therefore, zoning a property can be cumbersome. Developers who want to zone a real estate property in the state in which the company resides also experience some level of difficulty because the various local zoning ordinances can be different.

Engaging and conducting business with contractors in other states can pose additional logistical problem for developers. There is currently no central point for a developer to contact a contractor, verify the contractor's license, and submit work for bidding.

There is a need for an information technology platform that facilitates multi-jurisdiction zoning activities in an effective, efficient, and cost saving manner.

### SUMMARY OF THE INVENTION

Methods, systems, and articles of manufacture consistent with the present invention assist a user, such as a real estate developer, with meeting zoning, SUP, and variance requirements in a plurality of jurisdictions. A database includes zoning, SUP, and variance requirements and configuration parameters. This information may be used to determine an appropriate solution for zoning in a particular jurisdiction. The zoning, SUP, and variance requirements are updated periodically to reflect changes to existing requirements and the addition of new requirements. Upon selection of a specific zoning jurisdiction from a plurality of zoning jurisdictions, the system automatically determines the applicable zoning requirements and presents them to the user. The system automatically notifies relevant active users when a zoning rule changes.

A zoning applicant user can submit a description of work for a zoning case to engage contractors to bring a property into compliance with the building code and zoning requirements. The system also provides a platform that enables building contractors to bid for structural, electrical, mechanical, plumbing, and other work required to bring a property into compliance with zoning and building code regulations applicable to a given jurisdiction. A contractor can view the description of work posted by the applicant and submit a bid. The applicant can review bids submitted online and select a winning bid.

To assist with the application process, the system automatically notifies the applicant of the date that public hearing zoning meetings will be held on the project, based on the scheduled public hearing date parameters calculated by the system. Further, the applicant may view the public hearing via live video presented by the system.

The system can provide significant cost savings for users and municipalities by optimizing and automating the intrastate and interstate zoning processes. Further, the system provides a more efficient way for users, such as developers and contractors, to communicate online.

In accordance with methods consistent with the present invention, a method for managing zoning project information for a plurality of jurisdictions is provided. The method comprises the steps of: providing a template for at least one of the jurisdictions, each jurisdiction being associated with at least one zoning requirement, each template including at least one zoning requirement of the respective jurisdiction; receiving a request to display the zoning requirements for at least one of the jurisdictions; and displaying the zoning requirements for the at least one jurisdiction responsive to the request.

In accordance with articles of manufacture consistent with the present invention, a computer-readable medium containing instructions that cause a data processing system to perform a method for managing zoning project information for a plurality of jurisdictions is provided. The method comprising the steps of: providing a template for at least one of the jurisdictions, each jurisdiction being associated with at least one zoning requirement, each template including at least one zoning requirement of the respective jurisdiction; receiving a request to display the zoning requirements for at least one of the jurisdictions; and displaying the zoning requirements for the at least one jurisdiction responsive to the request.

In accordance with systems consistent with the present invention, a data processing system for managing zoning project information for a plurality of jurisdictions is provided. The data processing system comprises: a memory having a program that provides a template for at least one of the jurisdictions, each jurisdiction being associated with at least one zoning requirement, each template including at least one zoning requirement of the respective jurisdiction; receives a request to display the zoning requirements for at least one of the jurisdictions; and displays the zoning requirements for the at least one jurisdiction responsive to the request. A processing unit runs the program.

In accordance with systems consistent with the present invention, a data processing system for managing zoning project information for a plurality of jurisdictions is provided. The data processing system comprises: means for providing a template for at least one of the jurisdictions, each jurisdiction being associated with at least one zoning requirement, each template including at least one zoning requirement of the respective jurisdiction; means for receiving a request to display the zoning requirements for at least one of the jurisdictions; and means for displaying the zoning requirements for the at least one jurisdiction responsive to the request.

The above-mentioned and other features, utilities, and advantages of the invention will become apparent from the following detailed description of the preferred embodiments of the invention together with the accompanying drawings.

Other systems, methods, features, and advantages of the invention will become apparent to one having skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention.

FIG. 1 is a block diagram of an illustrative data processing system consistent with the present invention.

FIG. 2 is a block diagram of a zoning system consistent with the present invention.

FIG. 3 is a block diagram of a user system consistent with the present invention.

FIG. 4 is a flow diagram depicting illustrative steps performed by the zoning program for user registration and configuring a zoning jurisdiction.

FIG. 5 is a flow diagram depicting illustrative steps performed by the zoning program during a zoning project workflow.

FIG. 6 is a flow diagram depicting illustrative steps performed by components of the zoning program.

### DETAILED DESCRIPTION OF THE PRESENTLY PREFERRED EMBODIMENTS

Reference will now be made in detail to an implementation consistent with the present invention as illustrated in the accompanying drawings. Wherever possible, the same reference numbers will be used throughout the drawings and the following description to refer to the same or like parts.

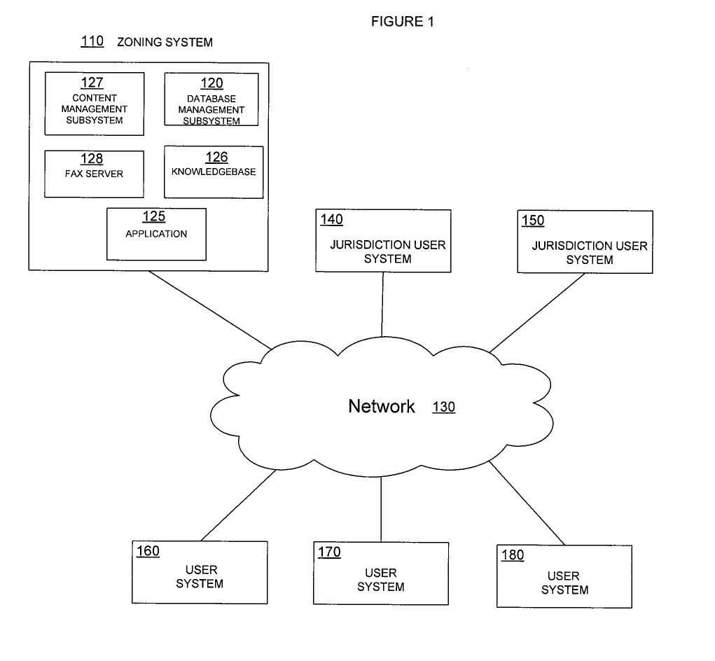

Methods, systems, and articles of manufacture consistent with the present invention enable a user to determine the appropriate zoning, SUP, and variance requirements for a given zoning jurisdiction, and to manage contractor bids for projects in the jurisdiction. For purposes of this disclosure, the term “zoning” refers to zoning, SUP, and variance. FIG. 1 depicts an illustrative data processing system 100 suitable for use with methods, systems, and articles of manufacture consistent with the present invention. Data processing system 100 includes a zoning system 110, which has a zoning database 120, an application server 125, a knowledgebase server 126, a content management server 127, and a fax server 128. As will be described in more detail below, the zoning database includes zoning, SUP, and variance information for various jurisdictions, such as local and state regulations. The zoning database, application server, knowledgebase server, content management server, and fax server may also include additional information that would assist a user, such as a developer, with managing projects in the various jurisdictions. For example, the illustrative zoning database, application server, knowledgebase server, content management server, and fax server include information about applicants and enable the user to submit zoning packages, for projects in the various jurisdictions, that meet zoning requirements of the respective jurisdictions.

The zoning system may be coupled to a network 130, such as the Internet, to facilitate communication with other entities. For example, the zoning system may communicate with data processing systems at one or more government entities 140 and 150, such as states, towns, and cities, to obtain relevant zoning laws and updates for storage in the zoning database. The zoning system may also communicate with data processing systems at one or more users 160, 170, and 180, such as administrators, zoning applicants, contractors, and print-mail shop users. As depicted, the users may access and utilize the system using a variety of devices such as cellular telephones, personal computers, and the like.

In the illustrative example, the various components communicate via the Internet using cable modems, dial-up modems, and the like. Users access the data processing system through a web browser interface. The zoning system includes a web server and the user systems include a web browser. The information displayed in the web browser is transmitted from the zoning system, which is a server, using TCP/IP and other protocols. The various programs and modules may be implemented in hypertext markup language and other languages supported by the web browser.

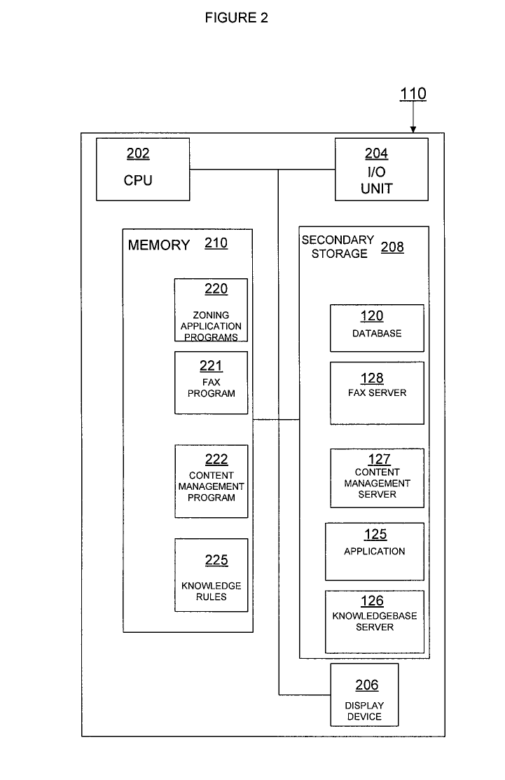

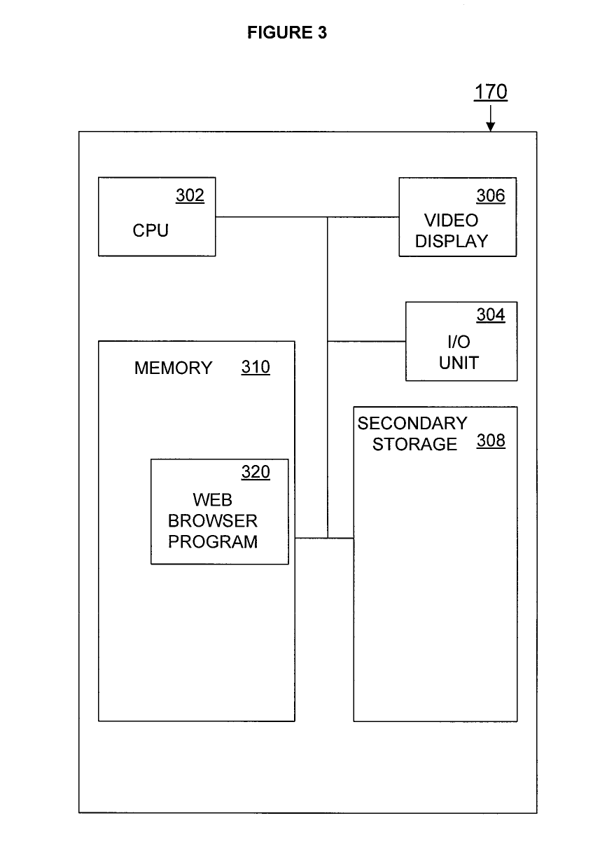

FIGS. 2 and 3 depict more detailed views of illustrative zoning and user systems, respectively. FIG. 2 depicts a more detailed view of the zoning system. The zoning system comprises a central processing unit (CPU) 202, an input/output (I/O) unit 204, a display device 206, a secondary storage device 208, and a memory 210. The zoning system may further comprise standard input devices such as a keyboard, a mouse or a speech processing means (each not illustrated). Memory 210 includes a zoning program 220, which is described in more detail below. The memory may also include a fax program 221, a content management program 222, and knowledge rules 225. The zoning database 120 may be located, for example, in the zoning system secondary storage or remotely from the zoning system. In the illustrative example, the zoning database 120 is located in the zoning system secondary storage. The secondary storage may also include the application server 125, the knowledgebase server 126, the content management server 127, and the fax server 128.

The application server manages application programs, such as the zoning program. The knowledgebase server is used to manage the knowledgebase, which may include, for example, help guides and other information that can be accessed by the users. The content management server manages distribution of content, such as zoning meeting video streams and the like. The fax server manages distribution of facsimile transmissions, such as notices transmitted by facsimile. The general functionality of each of these servers is known to one having skill in the art and will not be described in more detail herein.

FIG. 3 depicts a more detailed view of the user system, such as user system 170 that is used by a developer in the illustrative example. The user system may be used by another type of user, such as a contractor, appraiser, or other type of user. The zoning system comprises a central processing unit (CPU) 302, an input/output (I/O) unit 304, a display device 306, a secondary storage device 308, and a memory 310. The user system may further comprise standard input devices such as a keyboard, a mouse or a speech processing means (each not illustrated). Memory 310 includes a web browser program 320 that allows a user to access the zoning system via the network.

One having skill in the art will appreciate that each program and module described herein can be a stand-alone program and can reside in memory on a data processing other than the described systems. The program and modules may comprise or may be included in one or more code sections containing instructions for performing their respective operations. While the programs and modules are described as being implemented as software, the present implementation may be implemented as a combination of hardware and software or hardware alone. Also, one having skill in the art will appreciate that the programs and modules may comprise or may be included in a data processing device, which may be a client or a server, communicating with the described system.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; or other forms of ROM or RAM either currently known or later developed. Further, although specific components of data processing system 100 have been described, one skilled in the art will appreciate that a data processing system suitable for use with methods, systems, and articles of manufacture consistent with the present invention may contain additional or different components.

One having skill in the art will appreciate that the zoning and user systems can themselves also be implemented as client-server data processing systems. In that case, a program or module can be stored on, for example, the zoning system as a client, while some or all of the steps of the processing of the program or module described below can be carried out on a remote server, which is accessed by the server over the network. The remote server can comprise components similar to those described above with respect to the zoning system, such as a CPU, an I/O, a memory, a secondary storage, and a display device.

In the illustrative embodiment, the zoning database comprises a plurality of modules, which are data structures, that include records relating to the zoning case. One having skill in the art would appreciate that the various records may be divided into a different number of modules or assigned to other modules that those described in the illustrative example. Further, the records may be substituted with different record information as required by the various jurisdictions and user needs. The zoning database comprises the following illustrative modules:
A Global Configuration Module that includes a template record (or template) for meeting the requirements of each Zoning Jurisdiction. A Zoning Jurisdiction may be, for example, a city, state, or municipality. A template is a data structure that may include one or more of (a) requirements for notifying neighbors, (b) requirements for postal mailing confirmation, (c) requirements for notification via posted sign, (d) requirements for notification via newspaper, (e) requirements for letter of intent to zone, (f) requirements for site plan, (g) requirements for zoning application submission, (h) requirements for vicinity map, (i) requirements for zoning notice letter, (j) requirements for obtaining notification addresses, (k) requirements for meeting building code compliance, (l) and any new zoning requirements, (m) requirements for SUP, (n) requirements for variance, and the like. A Global Configuration Template is a master template that includes all records that may be implemented. A Jurisdiction Template record is a subset of the Global Configuration Template and is specific to a particular jurisdiction. Initially, the Jurisdiction Template record is blank, and later populated by information from the Global Configuration Template.
A Jurisdiction Configuration Module comprises a Jurisdiction Configuration record for each Zoning Jurisdiction and other records, such as a Jurisdiction Deliverable record that defines the deliverables for the jurisdiction. The records comprise a subset of the requirements described in the Global Configuration Template. For example, a Jurisdiction Deliverable record may comprise (a) neighborhood notification letter, (b) site plan, (c) letter of intent, and (d) public hearing requirement.
A Municipality Admin Module comprises a Zoning Case record for each applicant. Each record includes a Zoning Case Identifier, which is a unique identifier formatted specifically for each zoning jurisdiction, address of the property being zoned, the type of property, number of acres, contact person, and the proposed zoning classification. The Zoning Case Identifier is used as a keyed field to extract notification addresses from the database.
A Bid Submission Module comprises a population of various types of compliance reports submitted for viewing by registered contractors. The reports include, for example, a structural compliance report, a electrical compliance report, a plumbing compliance report, a mechanical compliance report, and other compliance requirements. These reports and other compliance requirements would be known to one having skill in the art and are not described in further detail herein.
A Contractor Module comprises the population of registered contractors.
A Bid Status Module comprises the population of contractor bids and an indicator in each bid record reflecting the current status of the bid.
A Bid Result Module comprises the population of bid records that have been reviewed by the zoning applicant. Each record comprises information about the contractor that has been selected, such as contact information and bid results, and notification that the bidding window is closed.
An Open Bid Module comprises the population of compliance reports that have been submitted for bidding for which bidding is in process.
A Zoning Package Generation Module comprises the population of requirements that a zoning jurisdiction requires a zoning applicant to mail to adjacent property owners.
A Zoning Package Printing Module comprises the population of deliverables for Zoning Cases that are available for printing.
A Public Meeting Notification Module comprises alert notices for each public hearing meeting held for a specific set of Zoning Cases in a given zoning jurisdiction. The alert notices include, for example, a date, time, location, and description of the relevant zoning case.

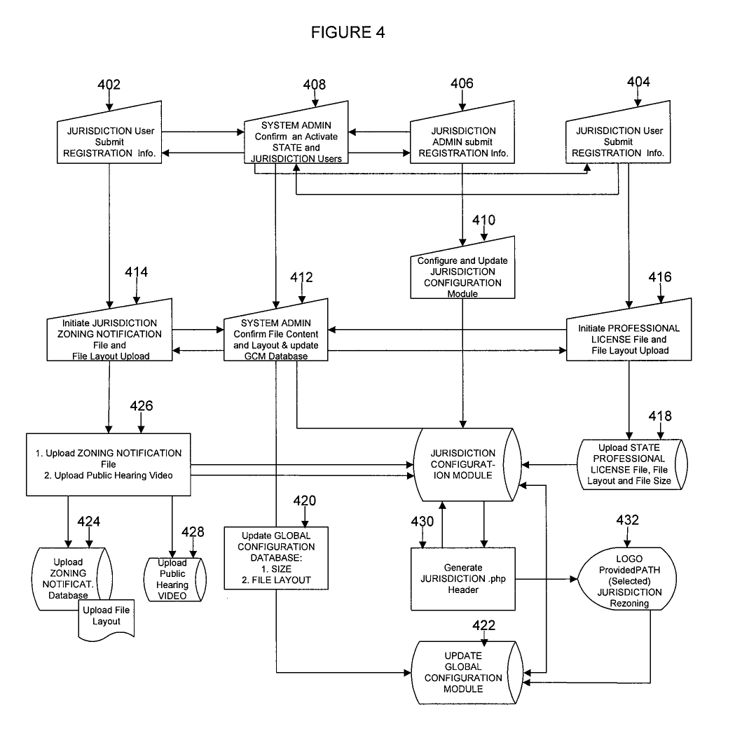

FIG. 4 is a flow diagram that depicts illustrative steps performed by the zoning program and user systems for user registration and system configuration. Initially, the zoning program automatically enables the Global Configuration Template and the Jurisdiction Configuration Record for each relevant jurisdiction. As described above, the Global Configuration Module contains the full complement of zoning, SUP, and variance requirements for all zoning jurisdictions that have been defined in the system. The Jurisdiction Configuration Module initially contains a shell or template designed to programmatically extract the specific set of zoning rules from the Jurisdiction Template Record of the Global Configuration Module.

Further, the zoning program generates web page screens, for example in HTML, PHP, and the like, for each zoning jurisdiction and stores these screens as templates in the Jurisdiction Configuration Module (step 430). The screen displays, for example, the name of the respective zoning state and a list box containing the listing of all of the zoning jurisdictions in that state. The resulting list box will be accessible by authorized users to access their specific zoning cases in their specific zoning jurisdictions (step 432). Additional screens may be presented that include additional information as described below.

Various users may register with the system from their respective user systems. In the illustrative example, a zoning applicant (step 402), a contractor (step 404), and a jurisdiction administrator, such as a state agency employee, (step 406) submit their registration information to the zoning system using their respective user system web browsers. Registration information includes, but is not limited to, name, contact information, professional licenses, and fees. A system administrator at the zoning system or at a client system that communicates with the zoning system authenticates each registrant and activates the various users on the system (step 408). Users may be provided access to information for one or more jurisdictions in accordance with the system administrator's policies.

The registered jurisdiction administrator can access and modify those records within the zoning database for which the jurisdiction administrator has received access privileges. For example, a jurisdiction administrator for the state of Georgia may have access and/or editing privileges for zoning records for the jurisdiction of Georgia. The jurisdiction administrator updates or modifies zoning, SUP, and variance rules in the relevant Jurisdiction Configuration Modules (step 410). This information may include, for example, zoning rule sets, a description of the zoning process, and relevant zoning documents. When a zoning, SUP, or variance rule changes, the zoning program automatically notifies registered users, such as users registered for the relevant jurisdiction.

In the illustrative example, the jurisdiction administrator updates a jurisdiction template record with a “Y” (yes) or “N” (no) flag for each requirement to indicate whether or not a requirement is applicable to the specific zoning Jurisdiction. The zoning program extracts the subset of zoning requirements for a specific jurisdiction from the Global Configuration Module based on the “Y” flag, and creates a Jurisdiction Configuration Record in the Jurisdiction Configuration Module for each zoning jurisdiction. The Jurisdiction Configuration Record is a subset of the Global Zoning Template applicable to that jurisdiction. The zoning program may activate and deactivate the various Jurisdiction Configuration Records as requested by the administrator.

Upon completion of the zoning jurisdiction configuration process by the jurisdiction administrator, the zoning program notifies the system administrator that the zoning jurisdiction configuration process is complete. After reviewing the registration and configuration process deliverables displayed on the screen, the system administrator may enter a positive confirmation request, if the deliverables appear to be accurate (step 412). Then, system administrator can enter an input that signals to the zoning program to bring the relevant zoning jurisdiction online for other users and update the Global Configuration Module with the Zoning Jurisdiction Configuration record. The jurisdiction administrator can access the relevant Jurisdiction Configuration Module to define and update new Zoning, SUP, and variance rules related to the specific zoning jurisdiction.

The jurisdiction administrator may also initiate upload of professional license (step 414) and zoning notification files (step 416), and file layouts for these files to the Jurisdiction Configuration Module and Global Configuration Module, respectively. The professional license file includes information fields for professional license information for each contractor, such as license number and the like. The zoning notification file includes zoning notification information, such as public hearing dates and times. Upon receiving automatic notification from the zoning program that a jurisdiction administrator has uploaded the professional license file (step 418) and zoning notification file and the respective file layouts to the Jurisdiction Configuration Module and the Global Configuration Module, respectively, the system administrator may verify the file size and the file format record in the Jurisdiction Configuration Module. A request for positive confirmation of the file size and the file layout information is send automatically via email to the appropriate contact person designated for the zoning jurisdiction; requiring the contact person to review and confirm the files size, date and time stamp, and file layout that was received by the system administrator. The file size and file layouts are displayed on the web browser screen for review by the jurisdiction administrator Admin or contact person, for example, to confirm the completeness and accuracy of the information.

Upon receipt of the positive confirmation from the zoning jurisdiction's authorized user, the system administrator inputs a request to the zoning program to update the Global Configuration Module with the file size and file format information (steps 420 and 422) and the updates the database with the zoning notification file (step 424). The zoning program automatically notifies the system administrator when the professional license file or zoning notification file, and their respective file size, date, and time stamps do not match or when a file was not uploaded to the system.

The zoning program also enables the jurisdiction administrator to upload a public hearing video file (step 426) and a property address database to the Jurisdiction Configuration Module as supplemental information specific to that zoning jurisdiction. The zoning program also notifies the system administrator when the jurisdiction administrator uploads the professional license database (step 418) containing the name, address, phone number, license type, license number, license status, and any complaints that have been filed against a licensee. Further, the system administrator is notified when the public hearing meeting video is uploaded to the system. Upon receiving automatic notification that a video file has been uploaded, the system administrator may initiate a request for positive confirmation and the system sends an email to the appropriate contact person designated by the zoning jurisdiction. This request requires the contact person to review and confirm the files size and date and time stamp that was received by the system administrator. The zoning program displays the file size, date and time stamp on the user system display device for review by the jurisdiction administrator or contact person to confirm the completeness and accuracy of the information. Upon receipt of the positive confirmation from the zoning jurisdiction's authorized user, the system administrator requests the zoning program to upload the video file to the database (step 428). The System Admin is automatically notified when the video is not uploaded to the system.

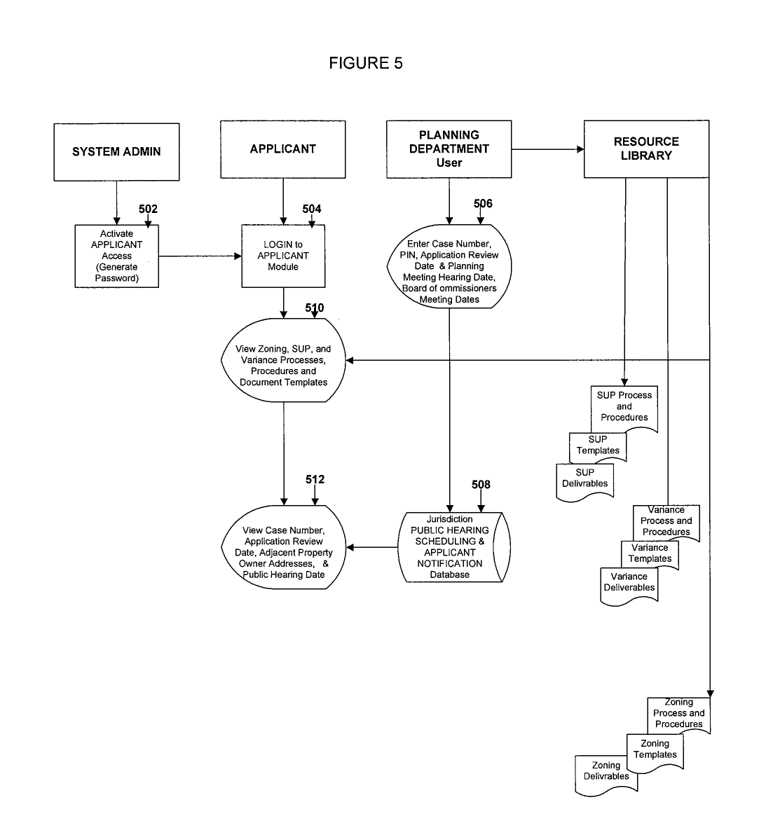

FIG. 5 is a flow diagram that depicts illustrative steps performed by the zoning program for creating a zoning case for a particular jurisdiction. In the illustrative example, the system administrator, applicant, and planning department are users that view screens, which have been generated by the zoning program, on their respective display screens, such as the user system or zoning system display screens.

When an applicant is first approved to use the system, the zoning program registers the user with the system and maintains a password for the user (step 502). Each time the registered user attempts to start a new session, for example, the user logs onto the system and enters the password (step 504). The applicant user submits an application to the zoning system by entering information about the property. Property information includes, for example, address, zoning change, applicant identification, and the like. A jurisdiction planning department user at the respective zoning jurisdiction user system can view the application and enter a zoning, SUP, and variance case number related to that zoning jurisdiction. The zoning jurisdiction planning department user can also enter meeting notification information into the system, for example, for (a) application review, (b) Planning Board Meeting, (c) Board of Commissioners Meeting, (d) reschedule of the Planning Board Meeting, (e) reschedule of the Board of Commissioner Meeting, and the like (step 506). The zoning program stores this information in the database (step 508).

The zoning program links the zoning case to a set of relevant zoning requirements defined in the Jurisdiction Configuration Module for the specific zoning jurisdiction. Then, the zoning program activates the zoning case after linking the zoning case to the appropriate set of zoning jurisdiction requirements defined in the Jurisdiction Configuration Module. If there are no relevant zoning requirements or if the wrong jurisdiction is selected, then the zoning case is not activated. Further, the zoning program prevents a zoning case record from being deleted when bidding or zoning compliance activities are in active status for that record. If the zoning case is no longer active, then the zoning program may unlink the zoning case from the Jurisdiction Configuration Module.

The zoning program automatically sends an email notification and posts an online notification on the web site informing the applicant about the meeting dates. Further, the zoning program updates and displays the number of days remaining to the scheduled meeting date.

In step 506, the zoning jurisdiction planning department user may also enter one or more property identification numbers (“PINs”) for each zoning case number; and the zoning program automatically generates the name and address of adjacent or proximate property owners required to be notified. These names and addresses are stored in the Notification Address Identifier record of the database. The applicant is automatically notified, for example, by email and web site posting when the PINs are entered into the system. The zoning program updates a Notification Address Identifier record when the address to be notified changes or the individual or company to be notified changes. Upon selection of each zoning case that has been linked to a set of Notification Address Identifiers, the addresses to which the notification package will be mailed may be displayed on the display device.

A postal confirmation module component of the zoning program generates a postal service report required by the relevant jurisdictions. The destination addresses and postal service reports are then printed. The zoning system also prints the notification package, which may include, for example, a zoning notification letter, site plan, street map, letter of intent, postal confirmation form, and address insert. The system can print the notification package local to the user or at a remote print-mail shop for printing, packaging, and mailing.

Before or after submitting an application, the applicant may view zoning, SUP, and variance procedures and document templates on the display screen (step 510). The processes, procedures, templates, and variables are retrieved from the database using rules defined in the knowledgebase. The knowledgebase includes, for example, lookup tables, links, and the like, for matching the user query to the user's desired information. After the application has been registered with the zoning system, the applicant may view the case number, application review date, adjacent property owner addresses, and meeting and hearing dates on the user system display screen (step 512). The applicant, zoning administrator, or system administrator, for example, may update a zoning case record for a specific zoning case within a zoning jurisdiction to reflect modifications, to correct errors, and changes to the applicant information.

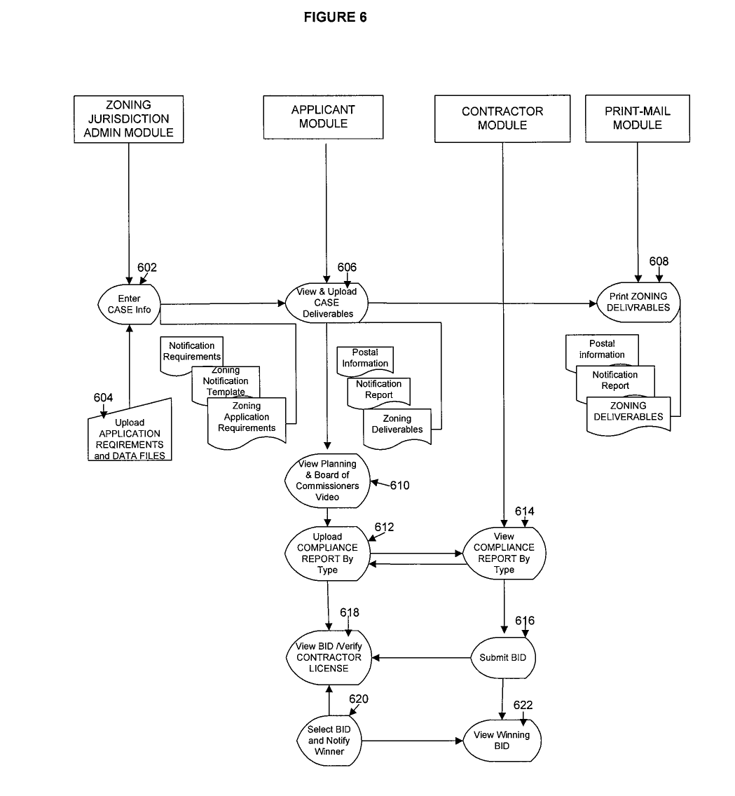

FIG. 6 is a flow diagram that depicts illustrative steps performed by the zoning program during the application and contractor bidding processes. As described previously, the zoning program receives zoning case information (step 602) and application requirements and data files (step 604). In the illustrative example, this functionality is performed by a zoning jurisdiction administration component of the zoning program.

The illustrative zoning program also includes an applicant module, a contractor module, and a print-mail module. As described above with reference to the zoning program, the applicant module component of the zoning program enables a logged-in applicant to view the zoning, SUP, and variance requirements for their respective zoning jurisdiction (step 606). Further, the applicant can view their zoning, SUP and variance applications and related information filed with the respective zoning boards. The applicant can automatically view the zoning notification deliverables, and other zoning application required by, for example, the jurisdiction planning department. The applicant can also upload the zoning application and supporting documents, such as a letter of intent, site plan, and street map.

To assist a user, the zoning program can generate and display statistical information relating to the various jurisdictions as well as global jurisdictional information. For example, a user may submit a query to determine the number of jurisdictions in the Global Configuration Module that require a specific deliverable. In the illustrative example, the jurisdictions may be ranked in the order of the number of deliverables required. The zoning program analyzes the various database records and outputs the query results to the user. In another example, the user can submit a query to determine the zoning jurisdictions that require the least number of deliverables. The user may also, for example, query for the total number of zoning cases in a particular jurisdiction or in all jurisdictions. In another example, the user may submit a query to determine the total number of zoning jurisdictions in the system or, for example, in a state.

After receiving the application, the zoning program automatically generates a zoning notification letter and a postal confirmation form. The zoning notification letter is addressed to owners of properties located near the property that is the subject of the zoning application. The applicant can either print the deliverables locally or request the zoning program to send the deliverables for printing at a remote print-mail shop (step 608). This latter case can be useful when the applicant wants to print a copy at a remote location.

The applicant can use the system to view public hearing meeting videos on line “on demand” or in real time mode (step 610). The applicant can also upload compliance reports (step 612) for viewing and bidding by contractors (step 614).

A contractor can view compliance reports that are open for bid using the contractor's user system. The zoning program may be configured to allow contractors to view only certain types of compliance reports, such as compliance reports that relate to they contractor's specialty (e.g., electrical, plumbing, and the like). A contractor may subsequently register for additional specialties by updating the contractor's profile. The zoning program may display compliance reports, for example, by type, such as by property or job type, or by jurisdiction. If a contractor wants to bid on a project, then the contractor submits a bid using at the contractor's user system (step 616). The bid may include, for example, the contractor's contact information, license information, bid amount, any stipulations, and the like. The contractor may select and view the status of its bids on the system.

The applicant views bids at the applicant's user system (step 618). The applicant enters an acceptance of the winning bid, for example, by selecting the winning bid using the web browser interface (step 620). Then, the zoning program notifies the winning contractor, for example, by email and by posting a notification on the web site. The winning contractor can then view the winning bid notification (step 622). The zoning program also notifies the other bidders, who did not have winning bids.

The print-mail module component of the zoning program enables a user to view the zoning, SUP, and variance deliverables, supplemental information, and print the deliverables that have been released by the Applicant (step 608).

Unlike conventional approaches that provide zoning information for a single jurisdiction, methods, systems, and articles of manufacture consistent with the present invention enable users to view zoning requirements and pursue projects in a plurality of jurisdictions. Further, the system provides a gateway for soliciting and awarding bids in multiple jurisdictions simultaneously. This beneficially simplifies the zoning application and zoning project processes, which were traditionally very time consuming and expensive.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed is:

1. A method in a data processing system having a program for managing zoning project information for a plurality of jurisdictions, the method comprising the steps of:
providing a template for at least one of the jurisdictions, each jurisdiction being associated with at least one zoning requirement, each template including at least one zoning requirement of the respective jurisdiction;
receiving a request to display the zoning requirements for the at least one jurisdiction; and
displaying the zoning requirements for the at least one jurisdiction responsive to the request.

2. The method of claim 1, wherein the zoning requirement include at least one of a zoning-related requirement, a special-use-permit-related requirement, and a variance-related requirement.

3. The method of claim 2, wherein the zoning requirement includes at least one of a neighborhood notification requirement, a postal confirmation requirement, a sign posting requirement, a newspaper publication requirement, a letter of intent requirement, a site plan requirement, a zoning application requirement, a vicinity map requirement, a zoning notice requirement, an address validation requirement, an electrical compliance requirement, an mechanical compliance requirement, a plumbing compliance requirement, a structural compliance requirement, and a public hearing meeting requirement.

4. The method of claim 1, further comprising the steps of:
receiving a request to initiate a zoning project in at least one of the jurisdictions, the request to initiate a zoning project including a property location information, an applicant identifier, and a scope of work information;
creating a zoning project case responsive to the request to initiate a zoning project; and
linking relevant zoning requirements for the relevant jurisdiction to the zoning project case.

5. The method of claim 4, further comprising the steps of:
soliciting bids to perform work related to the zoning project case;
receiving at least one bid to perform the work related to the zoning project case;
receiving an identification of a winning bidder to perform the work; and
notifying the winning bidder of the winning bid.

6. The method of claim 4, further comprising steps of:
identifying properties proximate to the property location; and
generating a notification report to send to the properties proximate to the property location.

7. The method of claim 4, wherein the zoning project includes a plurality of zoning projects in a plurality of jurisdictions.

8. The method of claim 1, further comprising the step of:
displaying a zoning requirement that has changed for at least one of the jurisdictions.

9. A computer-readable medium containing instructions that cause a data processing system to perform a method for managing zoning project information for a plurality of jurisdictions, the method comprising the steps of:
providing a template for at least one of the jurisdictions, each jurisdiction being associated with at least one zoning requirement, each template including at least one zoning requirement of the respective jurisdiction;
receiving a request to display the zoning requirements for the at least one jurisdiction; and
displaying the zoning requirements for the at least one jurisdiction responsive to the request.

10. The computer-readable medium of claim 9, wherein the zoning requirement include at least one of a zoning-related requirement, a special-use-permit-related requirement, and a variance-related requirement.

11. The computer-readable medium of claim 10, wherein the zoning requirement includes at least one of a neighborhood notification requirement, a postal confirmation requirement, a sign posting requirement, a newspaper publication requirement, a letter of intent requirement, a site plan requirement, a zoning application requirement, a vicinity map requirement, a zoning notice requirement, an address validation requirement, an electrical compliance requirement, an mechanical compliance requirement, a plumbing compliance requirement, a structural compliance requirement, and a public hearing meeting requirement.

12. The computer-readable medium of claim 9, further comprising the steps of:
receiving a request to initiate a zoning project in at least one of the jurisdictions, the request to initiate a zoning project including a property location information, an applicant identifier, and a scope of work information;
creating a zoning project case responsive to the request to initiate a zoning project; and
linking relevant zoning requirements for the relevant jurisdiction to the zoning project case.

13. The computer-readable medium of claim 12, further comprising the steps of:
soliciting bids to perform work related to the zoning project case;
receiving at least one bid to perform the work related to the zoning project case;
receiving an identification of a winning bidder to perform the work; and
notifying the winning bidder of the winning bid.

14. The computer-readable medium of claim 12, further comprising steps of:
identifying properties proximate to the property location; and
generating a notification report to send to the properties proximate to the property location.

15. The computer-readable medium of claim 12, wherein the zoning project includes a plurality of zoning projects in a plurality of jurisdictions.

16. The computer-readable medium of claim 9, further comprising the step of:
displaying a zoning requirement that has changed for at least one of the jurisdictions.

17. A data processing system for managing zoning project information for a plurality of jurisdictions, the data processing system comprising:
a memory having a program that
provides a template for at least one of the jurisdictions, each jurisdiction being associated with at least one zoning requirement, each template including at least one zoning requirement of the respective jurisdiction,
receives a request to display the zoning requirements for at least one of the jurisdictions, and
displays the zoning requirements for at least one jurisdiction responsive to the request; and
a processing unit that runs the program.

18. The data processing system of claim 17, wherein the zoning requirement include at least one of a zoning-related requirement, a special-use-permit-related requirement, and a variance-related requirement.

19. The data processing system of claim 18, wherein the zoning requirement includes at least one of a neighborhood notification requirement, a postal confirmation requirement, a sign posting requirement, a newspaper publication requirement, a letter of intent requirement, a site plan requirement, a zoning application requirement, a vicinity map requirement, a zoning notice requirement, an address validation requirement, an electrical compliance requirement, an mechanical compliance requirement, a plumbing compliance requirement, a structural compliance requirement, and a public hearing meeting requirement.

20. The data processing system of claim 17, wherein the program:
receives a request to initiate a zoning project in at least one of the jurisdictions, the request to initiate a zoning project including a property location information, an applicant identifier, and a scope of work information;
creates a zoning project case responsive to the request to initiate a zoning project; and
links relevant zoning requirements for the relevant jurisdiction to the zoning project case.

21. The data processing system of claim 17, wherein the program:
solicits bids to perform work related to the zoning project case;
receives at least one bid to perform the work related to the zoning project case;
receives an identification of a winning bidder to perform the work; and
notifies the winning bidder of the winning bid.

22. The data processing system of claim 17, wherein the program:
identifies properties proximate to the property location; and
generates a notification report to send to the properties proximate to the property location.

23. The data processing system of claim 17, wherein the zoning project includes a plurality of zoning projects in a plurality of jurisdictions.

24. The data processing system of claim 17, wherein the program:
displays a zoning requirement that has changed for at least one of the jurisdictions.

25. A data processing system for managing zoning project information for a plurality of jurisdictions, the data processing system comprising:
means for providing a template for at least one of the jurisdictions, each jurisdiction being associated with at least one zoning requirement, each template including at least one zoning requirement of the respective jurisdiction;
means for receiving a request to display the zoning requirements for at least one of the jurisdictions; and
means for displaying the zoning requirements for the at least one jurisdiction responsive to the request
